(19) United States
(12) Patent Application Publication
(10) Pub. No.: US 2012/0240448 A1
(43) Pub. Date: Sep. 27, 2012

(54) Gill Hook

(76) Inventor: Christopher C. Kemble, Saint Charles, IL (US)

(21) Appl. No.: 13/422,182

(22) Filed: Mar. 16, 2012

Related U.S. Application Data
(60) Provisional application No. 61/467,993, filed on Mar. 26, 2011.

(51) Int. Cl. A01K 97/14

(52) U.S. Cl. 43/5

(57) ABSTRACT

A gill hook for landing fish is disclosed, the hook has an elongate member having a handle at one end and a comparatively large hook at the opposite end.

### CROSS REFERENCE TO RELATED APPLICATIONS

This application claims the benefit of provisional patent application Ser. No. 61/467,993, filed Mar. 26, 2011, entitled “Gill Hook”.

### BACKGROUND OF THE INVENTION

1. Field of the Invention

The present invention relates to fish landing devices and more particularly to fish landing devices which use a hook to seize, hold and land a fish. Such fish landing devices include gill hooks and gaffs and will hereinafter be referred to as a “gill hook” or “landing hook”.

2. Description of the Prior Art

Most fish hooks are designed for initially landing the fish and then a larger landing hook or gaff is used to pull the fish onto a boat or land. These landing hooks are larger than the hooks used to catch the fish and usually employ a handle designed to maximize the ability of the fisherman to pull the fish, but not to immobilize the fish for removal of the initial hook. Further, landing hooks are designed to penetrate the body of the fish. Even after landing, the fish is capable of a great deal of unpredictable movement, which creates substantial risk of injury for the fisherman. It can also be a cause of damage to the fish itself, potentially destroying the food and/or trophy value of the caught fish.

U.S. Pat. No. 4,590,700 discloses a hinged landing hook. This sort of hook lowers the risk of inadvertent injury caused by an open hook, but also creates a less stable hook assembly that may give way under the force of a larger or stronger fish. Moreover, the segmented approach creates a greater potential for breakage and injury.

### BRIEF DESCRIPTION OF THE DRAWINGS

FIG. 1 is an elevational view of the gill hook of the invention prior to handle assembly.

FIG. 2 is an elevational view of the gill hook of the invention including a flat rectangular handle.

FIG. 3 is a fragmentary sectional view that depicts the gill hook of the invention being inserted into the rectangle handle.

FIG. 4 is an elevational view of the gill hook of the invention including a rounded handle.

FIG. 5 is a fragmentary sectional view that depicts the gill hook of the invention being inserted into the rounded handle.

FIG. 6 is an elevational view of the gill hook of the invention including a set of pliers prior to handle assembly.

FIG. 7 is an elevational view of the gill hook of the invention being used with a pair of pliers inserted into a rectangle handle.

FIG. 8 is an elevational view of the gill hook of the invention being used with a pair of pliers inserted into a rounded handle.

FIG. 9 is an elevational view of the gill hook of the invention being used with a set of pliers prior to handle assembly.

### SUMMARY OF THE INVENTION

The present invention comprises a gill hook especially suited for sports fishermen who are afoot or are in a small boat or who catch fish to be landed with or without a net. As such, the safety landing hook must be small enough to permit a fisherman to hold it with one hand while he/she holds the rod and positions the fish to insert the gill hook into the gills until it extends through the fish's mouth which will allow the fisherman to pick up the fish for hook removal. The fisherman can then choose to release or keep the fish without penetrating the body of the fish.

### DESCRIPTION OF THE PREFERRED EMBODIMENTS

The gill hook of the invention is a fishing tool used to pick up fish without getting stuck by fish fins, being bitten or getting spiked by the fish. It can be used while the fish is still in the water, while the fish is in a fish net, or after the fish has been brought on board a boat. To seize a fish, the beveled end of the gill hook is inserted through the fish's gills until it comes out through the fish's mouth. The fish can then be picked up to remove the fishing rod hook while maintaining control of the fish. Once the hook is removed, the fish is released by gently sliding the fish off the gill hook and back into the water or the fish cooler. For this purpose, the hook does not need any sharp edges nor a sharp point to hold a fish and it will not injure a fish when it is being landed.

The gill hook of the invention is formed as a shaft-like member, 4 to 12 inches long with a handle at one end of the shaft. Preferably, the other end of the shaft comprises a comparatively large hook. The elongate member may alternatively be a straight shaft without any hook at the end.

Multiple sizes of gill hook may be produced, preferably including small, medium, and large sizes.

1) Small sizes will be made small enough for fish up to 2 lbs such as bluegills, Crappie, and Perch.

2) Medium sizes be large enough for fish up to 12 lbs such Walleye, Small Mouth Bass, Crappie and Catfish, etc.

3) Large sizes will be available for fish up to 50-70 lbs such as Muskie, Catfish, Salmon, Steelhead, lake Trout, etc.

The gill hook of the invention may further include a weighted bottom, such as a lead ball, to the handle section to provide improved balance customization or to stun the fish before releasing it.

Regardless of the method a fisherman uses to catch fish, the gill hook of the invention is a fishing tool to make landing a fish much easier and safer for both the fisherman and the fish.

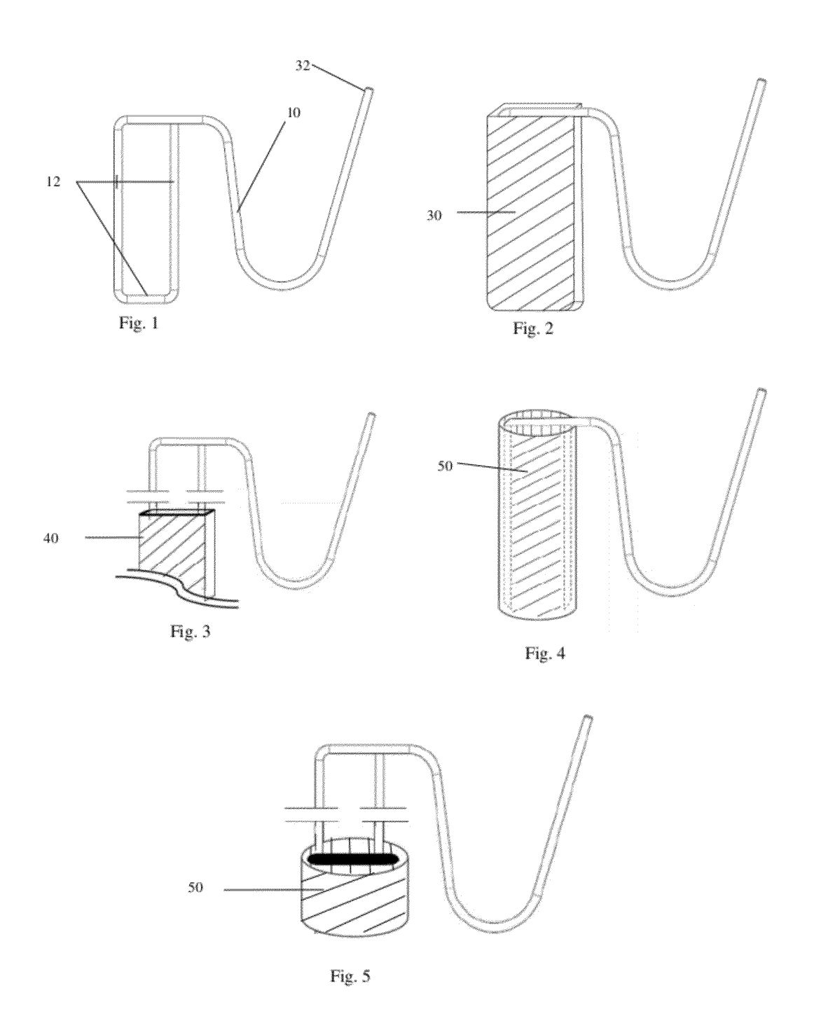

Referring more particularly to the drawings, FIG. 1 shows that the gill hook of the invention consists of a bent skeletal handle section 12 and a hooked shaft-like member or rod 10. The rod 10 is preferably constructed from sturdy, lightweight material such as a high strength aluminum or, preferably, stainless steel. It is circular in cross section, is of any suitable length, preferably 5 to 12 inches, and may be up to approximately 1-inch in diameter. The distal end of the gill hook has a smooth beveled end 32. The opposite extended end of the rod 10 is alternatively provided with a hole wherethrough a stationary or swivel-mounted ring is provided for attachment to a lanyard or the like, or to permit the gill hook to be hung upon a fastener.

FIG. 2 shows a handle grip 30 being mounted over the bent skeletal handle section 12. The handle grip 30 is a tubular member having a length suitable for easy gripping. The handle grip 30 is sized to fit snugly over the bent skeletal handle section 12 and may be affixed to the rod 10 as by an adhesive. The outer diameter of the handle grip 30 is on the order of 1-inch and is slightly tapered to a maximum diameter at its base, all in a conventional handle form. The handle form may be either rectangular shape 40 or rounded 50, as shown in FIGS. 3 and 4.

The handle grip 30 is preferably made of a material such as soft thermoplastic polyurethane, cork, plastics, plastic injected molded materials, wood, and solid metal fabricated handles or similar suitable material for secure gripping even when the handle is wet.

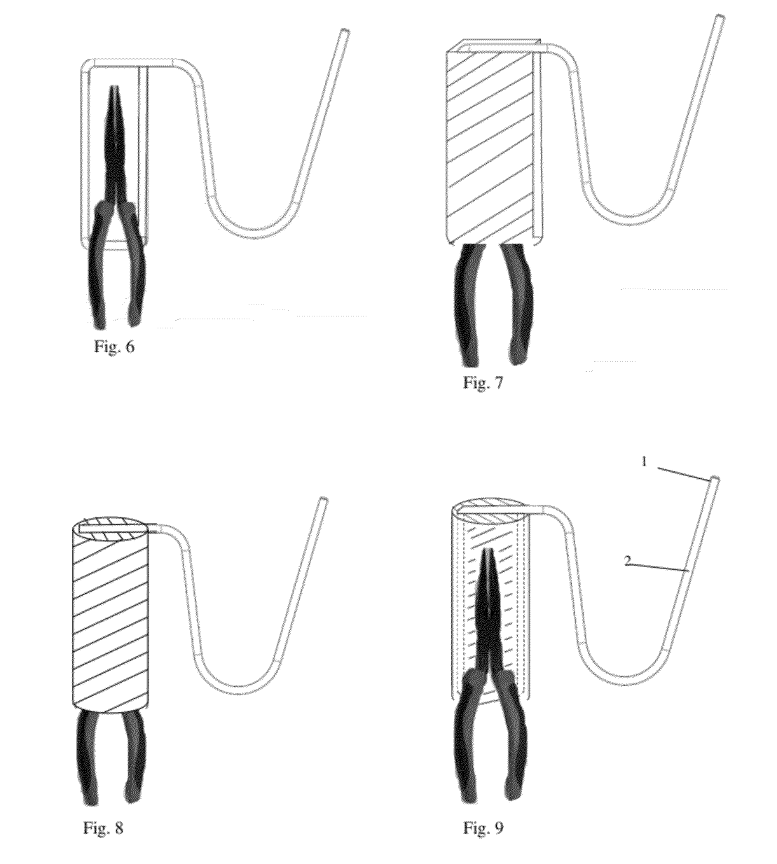

FIG. 6 shows an alternative embodiment of the gill hook of the invention wherein a set of pliers 60 or similar tools is incorporated into the gill hook prior to handle assembly. According to the alternative embodiment, there is no securing device for the pliers as the handle will stretch over the pliers securely holding them in place.

I have now described my invention in considerable detail, however, it is apparent that others skilled in the art can devise and build alternate and equivalent constructions which are within the scope and spirit of my invention. Hence, I desire that my protection be limited, not by the constructions and details as described, but only by the proper scope of the appended claims.

What is claimed is:

1. A gill hook for landing fish comprising an elongate member having a handle at one end and a comparatively large hook at the other end, with the handle portion nearest adjacent to the hook and the hook shank adjacent to the handle being a single, rod-like member.

2. The gill hook of claim 1, wherein the rod-like member is comprised of a material selected from the group consisting of aluminum and stainless steel

3. The gill hook of claim 1, wherein the handle portion comprised of a material selected from the group consisting of cork and thermoplastic polyurethane.

4. The gill hook of claim 1, wherein the handle portion further incorporates one or more removable tools.

5. The gill hook of claim 1, further comprising an adjustable weighted piece removably attached to the handle portion.

6. The gill hook of claim 5, wherein the weighted piece comprises a solid ball.

7. The gill hook of claim 5, wherein the weighted piece is in the shape of a ring.
